(19) United States
(12) Patent Application Publication
(10) Pub. No.: US 2005/0274832 A1
(43) Pub. Date: Dec. 15, 2005

(54) Granule spreader with a granule pump

(76) Inventor: Neil Edwin Bowsher, Sullivan, IL (US)

Correspondence Address: VEDDER PRICE KAUFMAN & KAMMHOLZ, 222 N. LASALLE STREET, CHICAGO, IL, 60601, US

(21) Appl. No.: 10/866,375

(22) Filed: Jun. 12, 2004

(51) Int. Cl. A01C 3/06

(52) U.S. Cl. 239/683; 239/684; 239/685; 239/687

(57) ABSTRACT

A granule spreader controls granule distribution by using a granule pump. The pump uses a rotating impeller that extracts measured amounts of granular material from a reservoir or hopper. Only the measured amounts are delivered to a rotary spreader for dispersal.

### BACKGROUND OF THE INVENTION

Granule spreaders, such as grass seed spreaders and fertilizer spreaders are well known. These devices typically have a holding tank or hopper for granular material to be dispersed. They also have some form of dispersing mechanism that receives granules from the hopper and either drops them horizontally onto the ground or distributes them radially.

A problem with prior art granule spreaders is their inability to accurately control the granule material delivery rate. Because granular material is difficult to handle, prior art granule spreaders control flow rate by increasing or decreasing an opening through which granular material flows vertically from the hopper to the dispersing mechanism. As such, granular material will continue to flow when the spreader is not moving across land to be treated. A spreader for granular material that provides flow control by relating the ground speed of a spreader to an amount that is pumped and dispersed to give a more consistent granule application would be an improvement over the prior art.

### SUMMARY OF THE INVENTION

Granule material is controllably delivered by gravity-feeding granules into partially-covered rotating vanes of an impeller. The impeller vanes carry the granules to an opening in the spreader hopper through which the granules fall onto a rotating plate that radially disperses the material.

### BRIEF DESCRIPTION OF THE DRAWINGS

FIG. 1 is an example of a granule spreader.

FIG. 2 is an exploded isometric view of a spreader hopper with a granule pump.

FIG. 3 is a top view of a granule measuring impeller used in the spreader for granular material depicted in FIG. 1 and FIG. 2.

### DETAILED DESCRIPTION OF THE PREFERRED EMBODIMENT

A granule is defined by the Merriam-Webster's Dictionary, Tenth Edition as a “small particle.” Individual grass seeds and solid fertilizer pellets are “granules.” Salt crystals and sugar crystals are also “granules. Grains of sand are small particles and are therefore “granules.” Ordinary flour is an aggregation of small particles; flour can therefore be considered to be granules.

The aforementioned dictionary definition of “granule” does not limit what is and what is not a “granule.” For purposes of this disclosure therefore, the term “granule” can therefore include very small particles but it can also include relatively large particles.

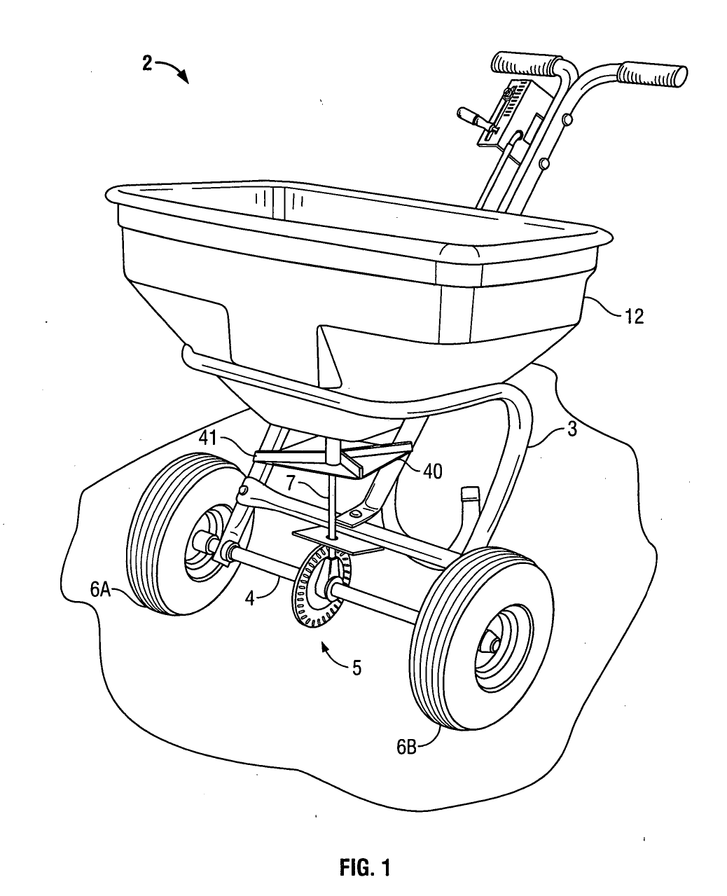

FIG. 1 shows a granule spreader 2 for use in dispersing fertilizer, grass seed or other granular materials. The spreader 2 is constructed from tubular steel or other rigid material that forms a frame 3, which supports a bin or hopper 12 in which granular material to be dispersed is stored.

The frame 3 and the hopper 12 can be easily moved about on first and second wheels 6A and 6B, which are rotatably connected to the frame 3. As shown in FIG. 1, the wheels 6A and 6B are coupled to each other by an axle 4, to which a ring gear 5 is attached in order to drive a small pinion gear (not shown) that is connected to a drive shaft 7. The ring gear 5 and pinion form a simple transmission that rotates the drive shaft 7 by rotation of the spreader's wheels 6A and 6B, i.e., by movement of the spreader 2 on a surface. Any other mechanism which translates rotational movement from one axis to another may also be used. Rotation of the drive shaft 7 turns a granule pump that is located inside the hopper 12 and a spreader plate 40.

Granules to be dispersed onto the ground from the bin or hopper 12, fall into the granule material pump inside the hopper 12, which measures granules to be dispersed and directs them onto the rotating plate 40. Vanes 41 in the rotating plate 40 act to throw granules radially, i.e. disperse them.

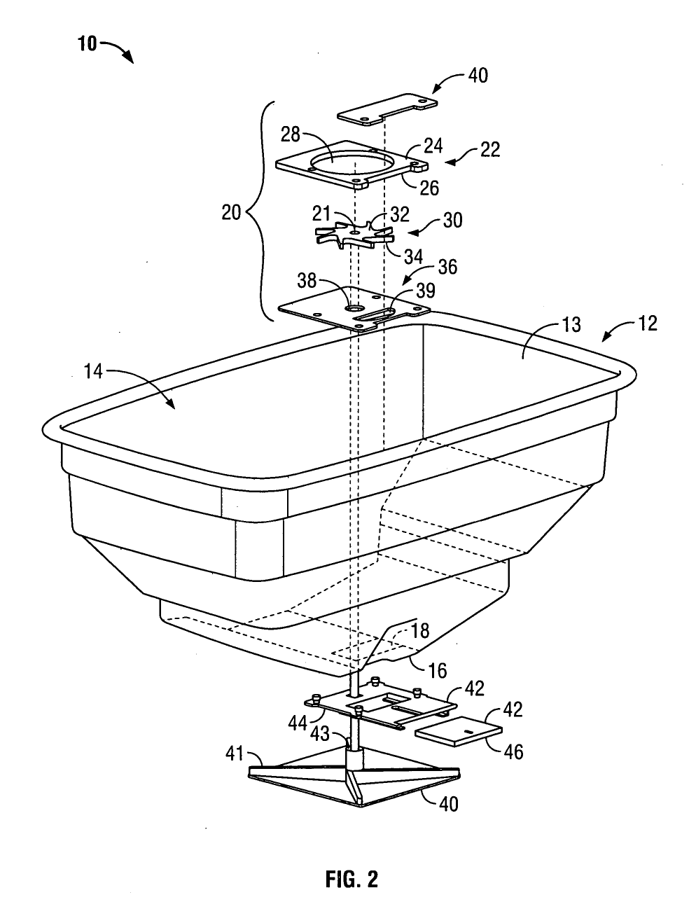

FIG. 2 shows an isometric view of the spreader's hopper 12, including an exploded view of the granule material pump 20.

The hopper 12 defines an open top 13 through which granular material to be distributed can be poured into the interior 14 of the hopper 12. As shown, the hopper 12 has a generally inverted frusto-pyramidal shape so that it's widest dimension is up, whereby granules are added through the wide end of the frusto-pyramid. The inverted orientation of the frusto-pyramid shape also helps move granules in the hopper 12 toward the center and bottom 16.

Granular material in the hopper 12 cannot flow directly to the opening 18 because of a granule measuring pump 20, attached to the hopper bottom 16 and over the bottom-located opening 18. By virtue of the hopper's inverted frusto-pyramid shape, gravity will cause granules in the hopper to fall toward the bottom 16 and into the granule measuring pump 20 input. Once granular material enters the granule measuring pump, it is carried by the pump to an opening in the bottom of the pump 20 that is directly above and aligned with the opening 18 in the hopper bottom 16. There is no direct, unobstructed pathway from the hopper interior 13 to its exterior; granules in the hopper 12 must pass through the pump.

Granules from the hopper 12 that are directed onto the rotating plate 40 are dispersed by the spreader vanes 41, the rotation of which radially accelerates granules outwardly where they fall to the ground or other surface onto which the granules are to be distributed.

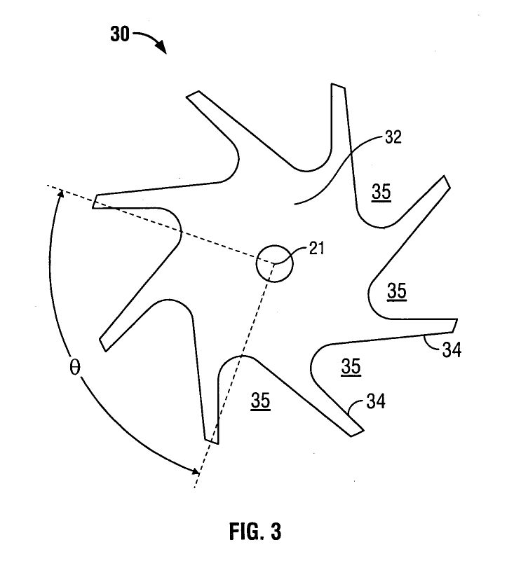

One embodiment of the granule measuring pump 20 is a four-piece assembly. It will be recognized by those of skill in the art that the number of pieces which make up the granule measuring pump 20 may be varied. The pump 20 uses a multi-vane impeller 30, which is also shown in greater detail in FIG. 3. The impeller 30 is constructed to have several vanes 34 with the space between each vane defined as an internal space or portion 35. Granules in the hopper 12 will fall into the internal space 35 as the impeller 30 rotates in the housing 22 of the pump 20. Because the amount of granular material that can occupy each internal space 35 is limited, each internal space 35 conveys a fixed or measured amount of granular material from the hopper 12 to the opening 18 in the hopper bottom 16. Adjacent ones of the impeller vanes 34, which extend radially from the central part 32 of the impeller 30, define additional internal portions 35 into which granules fall from the hopper 12. Granules in the other internal portions 35 are carried by the impeller 30 rotation to the opening 18 in the hopper bottom 16.

The granule measuring pump 20 is made up of a substantially planar pump housing 22, which has a planar top 24 and a planar bottom 26 and a centrally located opening 28, sized and shaped to enclose the aforementioned granule impeller 30. When the pump 20 is assembled, it's attached to the hopper bottom 16.

The top surface 24 of the housing 22 is partially covered by the top cover plate 40. Because the top cover plate 40 covers only a portion of the impeller 30, granular material above the impeller, i.e., above the pump 20, can fall into at least some of the spaces 35 between each of the impeller vanes 34 that are exposed to the interior 14 of the hopper 12. The portion of the impeller 30 that is not covered by the top cover plate is considered to be the pump opening or inlet, into which granules above the pump inlet can pass. As shown in FIG. 3, vanes 34 that are open or exposed to granular material above the pump can be considered to cover a certain area, which can be represented as subtending an angle 0, measured with respect to the impeller's axis of rotation 21.

A pump housing bottom cover plate 36 has a first centrally located opening 38 through which a drive shaft can pass to be coupled to the impeller 30. A second opening 39 in the bottom plate 36 is aligned to the opening 18 in the bottom of the hopper 12 such that when the pump 20 and its components are assembled, granular material in the hopper 12 can exit the hopper opening 18 only by passing through the impeller 30. The second opening 39 in the bottom plate 36 is considered to be the pump's output. The second opening 39 in the bottom cover 36 covers only a portion of the area beneath the impeller 30. Importantly, the opening 39 subtends an angle less than 180 degrees, measured about the axis of rotation 21, so that granules do not have a direct pathway through the pump 20 but instead must be conveyed from the inlet to the offset pump outlet via the impeller 30.

As shown in FIG. 3, a central part 32 of the impeller 30 includes an opening through which a drive shaft extends and fixed to the impeller and whereat the impeller's axis of rotation 21 is located. Several granule-scooping vanes 34 extend away from that evenly spaced around the axis of rotation 21 and located away from the axis or rotation in the central part 32 of the impeller. These scooping vanes, 34 which are just outside the central part, define a volume 35 that carries granules. When the pump 20 is assembled into a granule spreader, the drive shaft that extends through the opening in the central part 32 of the impeller, rotates the impeller 30, causing it to rotate in the pump housing 22.

As shown in FIG. 2, the pump housing cover plate 40 partially covers the impeller vanes 34. Because the cover plate 40 lies above the second opening 39 in the pump housing bottom cover 36, which is aligned with the opening 18 in the hopper bottom 16. The pump housing cover 40 therefore prevents granule material in the hopper 12 from free flowing out of the opening 18. Granules can only leave the hopper through the impeller 30 vanes 34 as they are rotated about the impeller's axis of rotation 21. This overcomes the disadvantage of the prior art where granules would continue to flow when the spreader was not traversing the surface being treated.

As set forth above, the cover plate 40 restricts granule material from free-flowing out of the hopper 12. Granule delivery rate can therefore be controlled by the size, i.e., diameter of the impeller, the geometry of the vanes 34 and its rotational speed. Material delivery rate is also controlled by the depth or thickness of the impeller 30, which will determine the volume of material that can be moved by each impeller space 30. In addition to granule delivery rate, the configuration of the pump and its associated assembly elements function to limit the granule size that is dispersed. This is particularly advantageous when spreading a non-homogenous material such as rock salt, fertilizer or any other non-homogeneous material.

In the preferred embodiment, the bottom plate 36 of the granule pump 20 lies against the bottom 16 of the hopper 12. The bottom plate 36 provides a wear plate for the impeller 30 but it also provides an opening 39 through which granules pass to the spreader plate 40. It will be recognized by those of skill in the art that the granule pump may also be disposed external of the hopper and perform the intended function. For example, the granule pump may be connected to the exterior bottom of the hopper in communication with an opening in the bottom of the hopper and perform the intended function described herein.

The bottom plate 36 actually has two openings, the first 38 of which accepts a drive shaft for the pump impeller 30. The second opening 39 is aligned with the hopper opening 18 and coupled to the hopper bottom 16. As shown on FIG. 2, the dimensions of the second opening 39 are such that it will subtend an angle that extends only partially around the first opening 38. The second opening 39 should be sized and shaped so that there is no direct pathway from the hopper interior 13 to its exterior. In one preferred embodiment the second opening 39 in the bottom plate 36 is substantially the same size as the bottom opening 18.

It is important to note that the second opening 39 of the bottom plate 36 should be sized and shaped so that all of the granule material carried in the interior 35 of the impeller will fall away from the portion of the impeller that is over the second opening 39. If the second opening 39 is too small, granules that don't fall away from the impeller will remain in the impeller until the opening is enlarged.

Because the impeller 30 in the pump rotates on a drive shaft that also drives the spreader, the pump needs to be fixed in the hopper 12 or it will tend to rotate with the drive shaft to which the impeller is attached. Indeed, as granules are collected in the pump housing 20, some of them will tend to become wedged between the rotating impeller 30 and the top cover plate 22 and the bottom cover plate 36. Fixing the pump 20 so that it can't rotate will help insure granule delivery.

The granule pump 20 in one embodiment shown in FIG. 2 is attached to the hopper bottom 16 by fasteners that extend through the bottom plate 36 into the hopper bottom 16. Alternatively, the pump 20 can be attached to the exterior of the hopper bottom 16 by fasteners that extend through the bottom plate 36, the top surface 24 of the housing 22 and into the hopper bottom 16. The pump 20 may be attached by mechanical fasteners, an adhesive or any other means as a design choice.

The drive shaft 7 (shown in FIG. 1) drives both the rotating spreader 40 and the impeller 30 and is driven by a conventional transmission between the spreader's wheels (not shown). Inasmuch as the impeller 30 and the spreader plate 40 are preferably driven by the same drive shaft, the central axes of the impeller 30 and the axis of the spreader 40 are preferably co-linear.

While the impeller 30 provides a controlled delivery of granule material from the hopper 12 to the spreader 40, it's also desirable to stop granule material from flowing from the spreader. The spreader 10 is therefore provided with a granule gate 42 comprised of a gate bracket 44 and a sliding gate 46. The granule gate 42, which is located between the spreader plate 40 and the opening 18 in the bottom 16, has a “first” or open position that will allow granules to drop from the opening 18 to the spreader plate 40. In the open position, the gate plate 46 is slid away from the sliding gate bracket 44. In a “second” or closed position, the gate 46 is slide into the gate bracket 44 such that granules cannot pass through the opening 18. In the closed position, the gate 46 is inserted into the gate bracket 44 and obstructs the passage of granule material thereby closing it into the hopper and preventing any dispersal of the granule material. The spreader may continue to be moved over the ground to be treated without causing damage to the spreader because the impeller will continue to rotate and the granules that fall into the volume 35 will be returned to the hopper 12.

From the foregoing, it should be apparent that an improved spreader for granular material is provided by a granule-measuring pump that positively collects granule material from the hopper and delivers it to the opening from the hopper for distribution by the rotating spreader 40.

1. A spreader for granular material from a hopper having an interior whereat granules are stored for dispersal and further having a bottom in which there is an opening through which granules can pass, the spreader comprising:
a granule pump, having an input through which granules from the hopper pass, said granule pump having an output operatively coupled the opening in the hopper bottom, the granule pump conveying measured amounts of granules from the hopper interior to the opening in the hopper bottom from where the granules can be dispersed; and
a rotating plate receiving granules from the granule pump output, through the opening in the hopper bottom, the rotating spreader radially dispersing granules.

2. The spreader of claim 1 wherein the granule pump is comprised of:
a housing having a substantially planar top and bottom and an opening that extends through the top and bottom;
an impeller in the opening in the housing, the impeller having a central part through which a drive shaft extends and from which a plurality of impeller vanes extend;
a housing bottom cover plate attached to the housing bottom, the bottom cover plate having an opening aligned with and coupled to the opening in the hopper bottom;
a housing top cover plate attached to the housing top, the top cover plate covering only a portion of the impeller

3. The spreader of claim 1 further comprised of a granule gate between the rotating spreader and the opening in the hopper bottom, the granule gate having an open position that allows granules to drop into the rotating spreader and a closed position that retains granules in the hopper.

4. A granule spreader comprising:
a granule hopper having a bottom opening through which granules stored in the hopper can pass to be dispersed;
a granule impeller (impeller) located in the hopper and proximate to the hopper bottom, said impeller having a centrally-located axis from which extend a plurality of vanes and about which the impeller rotates, a subset of the plurality of impeller vanes subtending an angle that extends at least partially over the opening in the hopper bottom;
a cover plate, covering at least the subset of the impeller vanes that extend over the opening in the bottom such that granules in the hopper are restricted from flowing directly through the opening in the hopper bottom, the cover plate being sized and shaped such that vanes of the impeller move granules from the hopper, under the cover plate to the opening in the hopper bottom that is below the cover plate; and
a rotating plate located below the hopper bottom, the rotating plate having a plurality of distribution vanes and a central axis around which distribution vanes rotate, the distribution vanes receiving granules through the hopper bottom and dispersing the granules by the distribution vane rotation.

5. The granule spreader of claim 4 wherein the axis of the impeller and the central axis of the rotating plate are substantially co-linear.

6. The granule spreader of claim 5 further including:
an impeller housing having a top, bottom and an opening extending through the top and bottom in which the impeller can rotate; and
said cover plate is configured and arranged to be attached to the impeller housing top, such that the housing and the cover plate enclose a subset of impeller vanes that subtend an angle that extends over the opening in the hopper bottom when the housing is attached to hopper bottom, the cover plate and the housing being structured and arranged to allow granules into the impeller vanes, when the impeller is rotated, each vane moving granules from the hopper, under the cover plate and to the opening in the hopper bottom.

7. The granule spreader of claim 6 further having a wear plate with top and bottom surfaces, the wear plate top surface being attached to the impeller housing bottom, the wear plate bottom surface being attached to the hopper bottom, the wear plate further having a first opening above and in substantial alignment with the opening in the hopper bottom.

8. The granule spreader of claim 7 wherein the opening in the wear plate includes a second opening through which a drive shaft for the impeller can extend, the wear plate first opening subtending an angle less than or equal to 180 degrees about said second opening.

9. The granule spreader of claim 7 further including a granule gate, located outside the bottom of the hopper, the granule gate having an open position that allows granules to pass through the opening in the hopper bottom, the granule gate having a closed position that prevents granules from passing through the opening in the hopper bottom.

10. The granule spreader of claim 7 further including a drive shaft, operatively coupled to the impeller and the spreader plate and which rotates the impeller and spreader plate.

11. The granule spreader of claim 4 further comprised of a drive shaft that extends through the impeller axis and through the central axis of the spreader plate.

12. The granule spreader of claim 4 wherein the hopper's shape is an inverted frusto-pyramid.

13. A granule spreader comprising:
a granule hopper having a bottom opening through which granules stored in the hopper can pass to be dispersed;
a granule measuring impeller located in the hopper and proximate to the hopper bottom, said impeller having a centrally-located axis from which extend a plurality of vanes and about which the impeller rotates, a subset of the plurality of impeller vanes subtending an angle that extends at least partially over the opening in the hopper bottom;
a cover plate, covering at least the subset of the impeller vanes that extend over the opening in the bottom such that granules in the hopper are restricted from flowing directly through the opening in the hopper bottom, the cover plate being sized and shaped such that vanes of the impeller move granules from the hopper, under the cover plate to the opening in the hopper bottom that is below the cover plate; and
a rotating plate located below the hopper bottom, the spreader plate having a plurality of distribution vanes and a central axis around which distribution vanes rotate, the distribution vanes receiving granules through the hopper bottom and dispersing the granules by the distribution vane rotation.

14. The granule spreader of claim 13 wherein the hopper's shape is an inverted frusto-pyramid.

15. A spreader comprising:
a frame;
first and second wheels, coupled to each other by an axle, which is rotatably mounted to the frame such that said wheels are rotatable;
a transmission having an input coupled to the axle and having an output which rotates when at least one wheel rotates;
a drive shaft, coupled to the transmission output;
a granule hopper having a bottom opening through which granules stored in the hopper can pass to be dispersed;
a granule measuring impeller operatively coupled to the drive shaft and located in the hopper and proximate to the hopper bottom, said impeller having a centrally-located axis from which extend a plurality of vanes and about which the impeller rotates, a subset of the plurality of impeller vanes subtending an angle that extends at least partially over the opening in the hopper bottom;
a cover plate, covering at least the subset of the impeller vanes that extend over the opening in the bottom such that granules in the hopper are restricted from flowing directly through the opening in the hopper bottom, the cover plate being sized and shaped such that vanes of the impeller move granules from the hopper, under the cover plate to the opening in the hopper bottom that is below the cover plate; and
a rotating plate that is also coupled to the drive shaft and located below the hopper bottom, the spreader plate having a plurality of distribution vanes and a central axis around which distribution vanes rotate, the distribution vanes receiving granules through the hopper bottom and dispersing the granules by the distribution vane rotation.

16. The granule spreader of claim 15 wherein the hopper's shape is an inverted frusto-pyramid.
